(19) United States
(12) Patent Application Publication
(10) Pub. No.: US 2007/0143114 A1
(43) Pub. Date: Jun. 21, 2007

(54) Business application dialogues architecture and toolset

(75) Inventors: Yim Y. Chan, Richmond Hill (CA); Nathaniel N. Kapauan, Ajax (CA); Ronald L.A. Wadey, Aurora (CA); Bernard Woo, Markham (CA); Howard Young, Richmond Hill (CA)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/313,312

(22) Filed: Dec. 21, 2005

(51) Int. Cl. G10L 21/00

(52) U.S. Cl. 704/270

(57) ABSTRACT

An application dialogue architecture and toolkit for creating an application dialogue in accordance with a predefined architecture. A toolkit is provided, comprising: a configurator tool for defining at least one frame, wherein each frame includes a set of talking points capable of being presented to an end user, and wherein the configurator tool includes a system for defining a unique model to be associated with each frame; and a content editor for populating and managing a content database associated with the application dialogue.

### FIELD OF THE INVENTION

The invention relates generally to computer implemented application dialogues, and more particularly, to an architecture and toolset for implementing application dialogues.

### BACKGROUND OF THE INVENTION

The evolution of information technology can be characterized by distinct phases of adoption. The first phase involved the proliferation of the mainframe, followed by the Personal Computer (PC) and then the Internet, or the e-business phase. Information technology has now entered into its next phase. Whether it is called the on demand Business (IBM), the Adaptive Enterprise (HP), Business Agility (Microsoft) or the Real Time Enterprise (Gartner), there is now significant innovation through technologies such as grid and autonomic computing.

The technologies being developed in this new phase are “smart” technologies. To provide insights into how “smart” applications may evolve, a business model may be adopted comprised of a three level triangle with Plan at the top, Control in the middle and Operate as the lower level. There are two types of information processes and flows occurring within the triangle; (a) transactions, and (b) business dialogues. This information flow can be viewed as transaction processing at the Operate level moving in a horizontal manner with vertical business dialogues occurring between the layers of the triangle. The process of Plan, Control and Operate are linked to provide an upwards dialogue flow for feedback or a downwards dialogue flow for direction/guidance creating a systematic, on going dialogue loop.

At the Operate layer the automation of processes is supported by transaction processing applications. These could include a bank deposit transaction, a point-of-sale credit card transaction, a new book ordered through the Internet or an inventory inquiry for goods in a warehouse. These types of transactions are short in duration, containing small amounts of data and while they were designed as discrete transactions, they can be strung together into a transaction flow. For instance, a customer may want to inquiry into their bank account balance, then transfer funds from their savings to checking account and finally, make a payment from their checking account. The data used in these transactions are of fixed format based upon physical information such as a bank account, the price of a product or the amount of inventory for a product.

Information that moves between the three layers produces business dialogue flows. Hence, the Operate transactions are monitored and managed by the Control layer. Exceptions to the operational processes are passed to the Control layer where experts are consulted to provide advice or modification to the business rules to standardize how these exceptions are handled. Information is summarized at the Control layer and passed to the Plan layer for performance evaluations and further dialogues. As new plans or targets are developed they are then filtered down as instructions to the Control layer and then to the Operate layer for execution.

These business dialogues can run for a few minutes such as when a user is seeking expert advice or several hours as in the case of a compliance assessment. A two-way information exchange results that goes beyond the regular transaction flow because expert knowledge is required to drive the discussion. Unlike information intensive applications which search and display content for users to determine their relevancy, business dialogues are prescriptive in nature. That is, their purpose is not just to find related information but to deliver advice within the context of the user situation. Examples of vertical dialogues include:
(1) Business information that is provided to experts to evaluate so that they can provide advice and guidance. An example of this would be a customer service representative who is unable to answer a customer's question and needs to involve 2^{nd} level support;
(2) Compliance assessments where information is collected and then analyzed for conformance so that actions can be determined to reduce potential risks and exposures; and
(3) Consultative selling situations involving dialogues where customer needs are established and then analyzed to determine the best product or solution recommendation.

Note that these types of dialogues are not strictly limited to business environments, but occur for other applications such as academia. Thus, for the purpose of this disclosure, the term “application dialogue” generically refers to all such dialogues. An important characteristic of these application dialogues are that they are two-way, interactive discussions between two parties, a user and a Subject Matter Expert (SME), involving specialist advice and content.

Because most organizations tend to have their own unique issues, best practices, information content, and expertise, typical application dialogues will vary significantly among different organizations. For instance, the type of business dialogue that might occur between a sales person and a sales consultant will be completely different than a person seeking guidance from an expert in performing a compliance assessment. Thus, the process of providing a computer implemented application dialogue infrastructure, e.g., where a user can obtain guidance from an expert base of knowledge, can be extremely costly, since the base of knowledge and types of inquiries are constantly changing. In most instances, significant programming skills are required to develop and maintain such an infrastructure. In most cases, the subject matter experts who are needed to populate such a knowledge base do not possess such programming skills.

Accordingly, a need exists for an architecture and toolset that will support computer implemented application dialogues without the need for significant programming skills.

### SUMMARY OF THE INVENTION

The present invention addresses the above-mentioned problems, as well as others, by providing an architecture and toolset that will support computer implemented application dialogues without the need for significant programming skills.

In a first aspect, the invention provides an application dialogue toolkit for creating an application dialogue in accordance with a predefined architecture, comprising: a configurator tool for defining at least one frame, wherein each frame includes a set of talking points capable of being presented to an end user, and wherein the configurator tool includes a system for defining a unique model to be associated with each frame; and a content editor for populating and managing a content database associated with the application dialogue.

In a second aspect, the invention provides a computer program product stored on a computer readable medium for creating an application dialogue in accordance with a predefined development protocol, comprising: program code configured for defining at least one frame in accordance with the predefined development protocol, wherein each frame includes a set of talking points capable of being presented to an end user; program code configured for defining a unique model in accordance with the predefined development protocol to be associated with each frame; and program code configured for populating and managing a content database associated with the application dialogue in accordance with the predefined development.

In a third aspect, the invention provides a method of creating an application dialogue in accordance with a predefined architecture, comprising: providing a development platform for building the application in accordance with a predefined development protocol; selecting at least one frame, wherein each frame includes a set of talking points capable of being presented to an end user; defining a unique model to be associated with each frame; and populating and managing a content database associated with the application dialogue.

In a fourth aspect, the invention provides a computerized architecture for implementing an application dialogue constructed in accordance with a predefined development protocol, comprising: a user interface; a runtime environment having a set of frames that make up the application dialogue, wherein each frame includes a set of talking points that can be used to display expert knowledge and receive input from an end user via the user interface, and wherein the each frame includes an associated model and logic that determines what talking points should be displayed to the end user within a frame, and when to switch between frames; and a content database for storing expert knowledge.

In a fifth aspect, the invention provides a method for deploying an application dialogue architecture and toolkit, comprising: providing a computer infrastructure being operable to: provide a user interface; provide a runtime environment having a set of frames that make up the application dialogue, wherein each frame includes a set of talking points that can be used to display content and receive input from an end user via the user interface, and wherein the each frame includes an associated model and logic that determines what talking points should be displayed to the end user within a frame, and when to switch from a first frame to a second frame; provide a content database for storing content; and provide a toolkit for defining the set of frames and associated model and logic, and for populating and managing a content database associated with the application dialogue.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an application dialogue architecture in accordance with the present invention.

FIG. 2 depicts an illustrative embodiment of an application dialogue architecture in accordance with the present invention.

FIG. 3 depicts a computer system having an application dialogue toolkit in accordance with an embodiment of the present invention.

FIG. 4 depicts an interface of an application dialogues toolkit for selecting frames in accordance with an embodiment of the present invention.

FIG. 5 depicts an interface of an application dialogues toolkit for creating questionnaire content in accordance with an embodiment of the present invention.

FIG. 6 depicts an interface of an application dialogues toolkit for creating graphical reporting content in accordance with an embodiment of the present invention.

FIG. 7 depicts a questionnaire interface of a runtime environment of a business application dialogue in accordance with an embodiment of the present invention.

FIG. 8 depicts a graphical reporting interface of a runtime environment of a business application dialogue in accordance with an embodiment of the present invention.

### DETAILED DESCRIPTION OF THE INVENTION

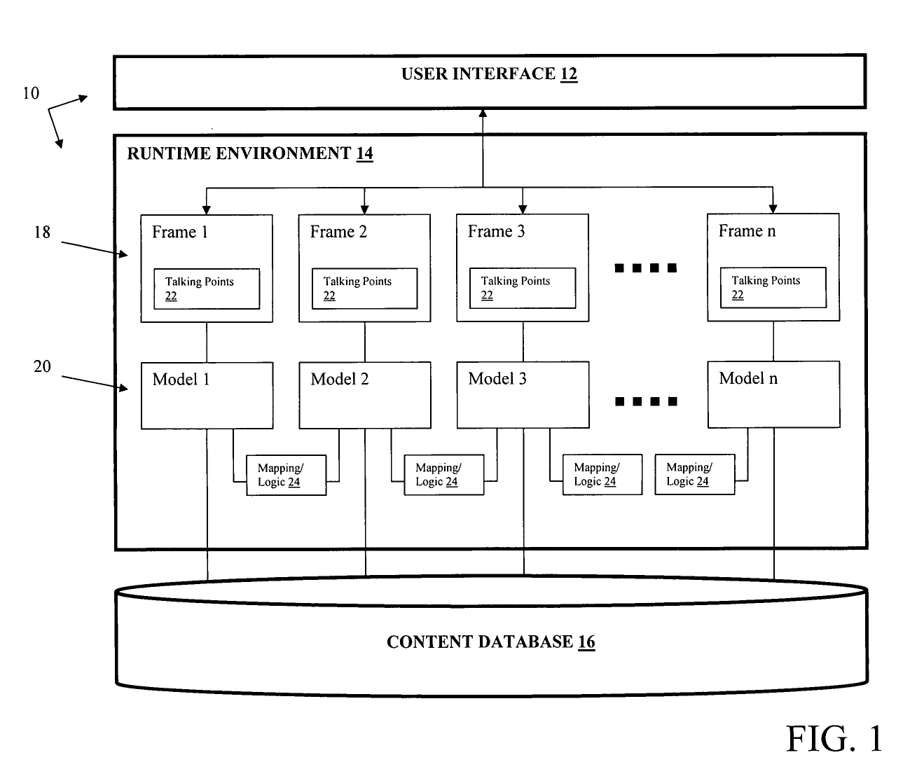

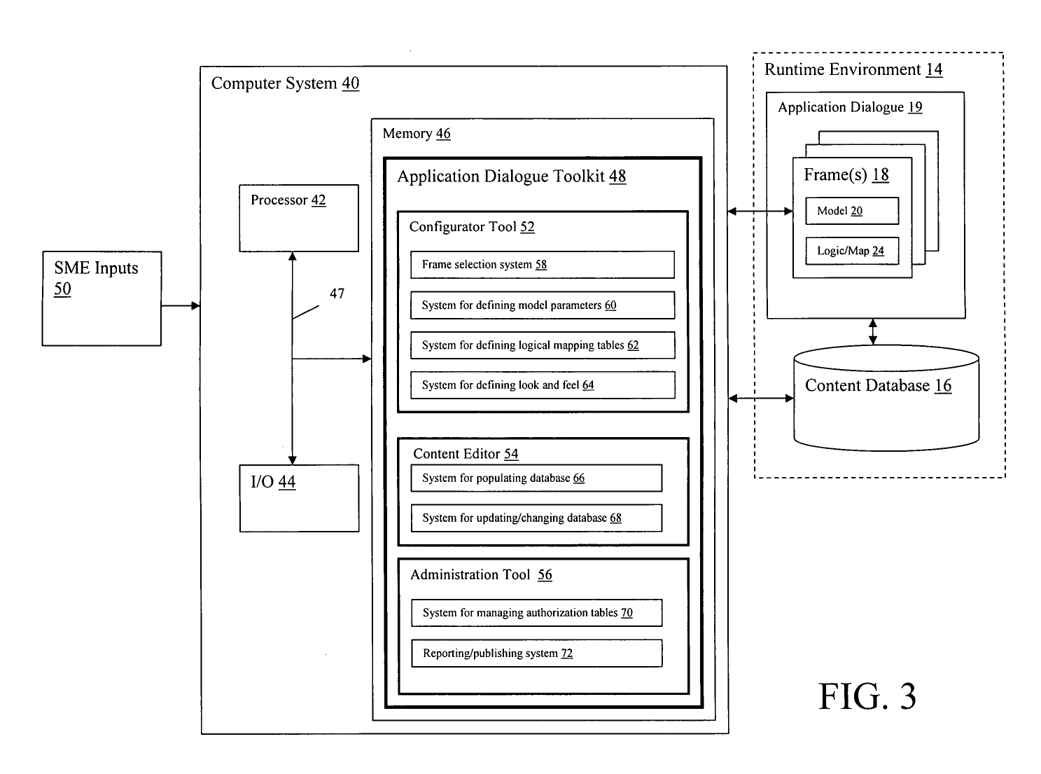

Referring now to drawings, FIG. 1 depicts a computer implemented application dialogue architecture 10 that can be utilized and applied, e.g., in any business dialogue environment. As described below in FIG. 3, architecture 10 is supported by an application dialogue toolkit 48 that allows the architecture 10 to be implemented without requiring significant programming skills. Instead, architecture 10 and application dialogue toolkit 48 provide a structured approach to composing application dialogues that can be used for any type of application.

Architecture 10 includes a user interface 12, a runtime environment 14 and a content database 16. User interface 12 may comprise any type of interactive interface that allows information to be inputted and outputted from the runtime environment 14. For instance, user interface 12 may be implemented in a Web application, a Windows environment, a handheld device, etc. Runtime environment 14 may be implemented using any computing platform, e.g., a personal computer, a handheld device, a laptop, etc.

Using the application dialogue toolkit 48 (described below), a developer, such as a subject matter expert, can create one or more discussion topics, or frames 18. Frames 18 can then be loaded into runtime environment 14, which can then be accessed by a user via user interface 12. Each frame 18 includes a set of talking points 22, which provide an interactive platform for exchanging information between the user and the subject matter expert's knowledge, which is stored in content database 16. Thus, the talking points 22 become the mechanism through which the user can explain their situation and express comments, and the subject matter expert can provide their point of view and expertise. Talking points 22 provide the basic elements that allow a detailed conversation within the frame to occur. Talking points 22 also provide a mechanism for organizing content within a particular context. Thus, by using talking points 22, only the relevant information that is needed by the user is presented, as opposed to overwhelming the user with large amounts of information at one time.

The runtime environment 14 is thus based upon a series of user interactive frames 18 that simplify the navigation through a dialogue and present content in manageable chunks so that the user is not overwhelmed by mountains of information. Behind each frame 18 is a unique model 20 that support each of the frames 18. To ensure that there is traceability in the logic flow, there is programming logic and a mapping 24 that ties each of the models 20 together so that each frame 18 can stand on its own and function within an overall application dialogue. Each model 20 provides access to the content database 16, where the subject matter expert's advice and knowledge for that particular application dialogue are stored.

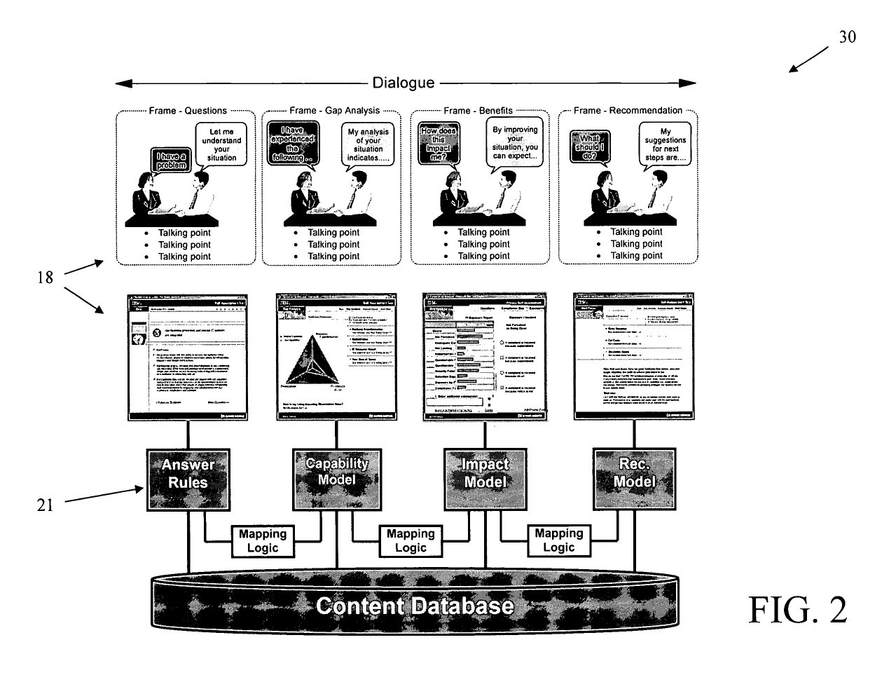

FIG. 2 depicts a specific embodiment of a business application dialogue 30 using the architecture 10 described in FIG. 1. In this case, a business application dialogue 30 is provided that includes four frames 18, including: questions, gap analysis, benefits, and recommendations. This particular dialogue might be useful in diagnosing problems occurring in an existing business process. In this example, a user would begin in the questions frame, where the user would be presented with a series of questions (i.e., talking points). Questions might be presented in a multiple choice or yes/no format relating to the current business process. The associated model in the case might include a set of answer rules 21, which dictate follow-up questions based on the answers given by the user. When the model determines that enough information has been collected in the questions frame, the dialogue proceeds to a gap analysis frame. The gap analysis frame provides various talking points based on a capability model that, e.g., would help identify gaps in the current business process. For instance, a gap analysis frame may suggest that there is a gap in the information technology (IT) resources required for the user's business process.

Next, the dialogue would proceed to the benefits frame, where the user would be presented with benefits of improving upon the identified gap, in this case, insufficient IT resources. In this example, the benefits frame is implemented with an impact model. Finally, the dialogue would proceed to a recommendations frame, where the user would be provided with various recommendations, based on a recommendations model, to address the identified gap in the business process. Obviously, the example shown in FIG. 2 is one possible type of application dialogue that could be implemented in accordance with the present invention. A system for building such an application dialogue is described below with regard to FIG. 3.

As shown in FIG. 3, the present invention provides an application dialogue toolkit 48 that utilizes a predefined development protocol for building application dialogues that adhere to the architecture described above. The predefined development protocol may be implemented within a user-friendly development environment in which construction of the application dialogue and process of producing content to support the frame talking points is done without the involvement of IT or programmers. In one illustrative embodiment, the development environment provides a series of user friendly interfaces, options, rules, etc., that allows the developer (e.g., a SME) to construct an application dialogue.

In the embodiment shown in FIG. 3, application dialogue toolkit 48 resides on a computer system 40 and provides a platform for creating frames 18 and content database 16 based on subject matter expert (SME) inputs 50. Note that for the purposes of this disclosure, the term SME refers to any person who uses the application dialogue toolkit 48 to develop an application dialogue. Application dialogue toolkit 48 comprises: a configurator tool 52, which includes a frame selection system 58; a system for defining model parameters 60; a system for defining logic and mapping tables 62; and a system for defining the look and feel 64 of, e.g., talking points presented to the user. Each of the systems in configurator tool 52 may be implemented with a set of user-friendly interfaces, e.g., as fill-in the blank/step-by-step processes. For instance, using configurator tool 52, an SME would first define (e.g., select) the appropriate frames to support his/her dialogue; then define any parameters used in the model for each frame; then select the logic and mapping tables to support the flow of logic through the dialogue; and then define the look and feel of the dialogue. Once all the SME inputs 50 (e.g., using fill-in the blank steps) are entered in the application dialogue configurator tool 52, the application dialogue is essentially “programmed,” without needing to know or have any programming skills.

The next tool is the application dialogue content editor 54, which provides an easy to use facility for entering content to populate/manage the content database 16, without requiring any knowledge of the underlying database or technical infrastructure. The final end user tool is the administration tool 56 used for administration functions. This is where, e.g., authorization tables can be set up so that different access privileges can be given to SMEs, users or Administrators.

Once created, an application dialogue 19, comprised of a set of frames 18, can be run in a runtime environment 14 by an end user. Illustrative runtime environments 14 may include, e.g., a computer, client server environment, etc.

The application dialogue toolkit 48 allows SMEs to create or change the application dialogue 19 without IT involvement or support. This means that the moment the SME decides a new application dialogue 19 is needed, the application dialogue 19 can be easily built by the SME, and once completed, and the application dialogue 19 is ready to be used. Application dialogues can be launched as needed and can be dynamically built during runtime execution pulling in the latest expert advice based upon the user's situation.

Note that any type of application dialogue 19 may be built using the toolkit 48 described herein. Examples include, but are not limited to: advising, consulting, consultative selling, compliance, and assessments and diagnostics executed in support of an existing business process or transaction.

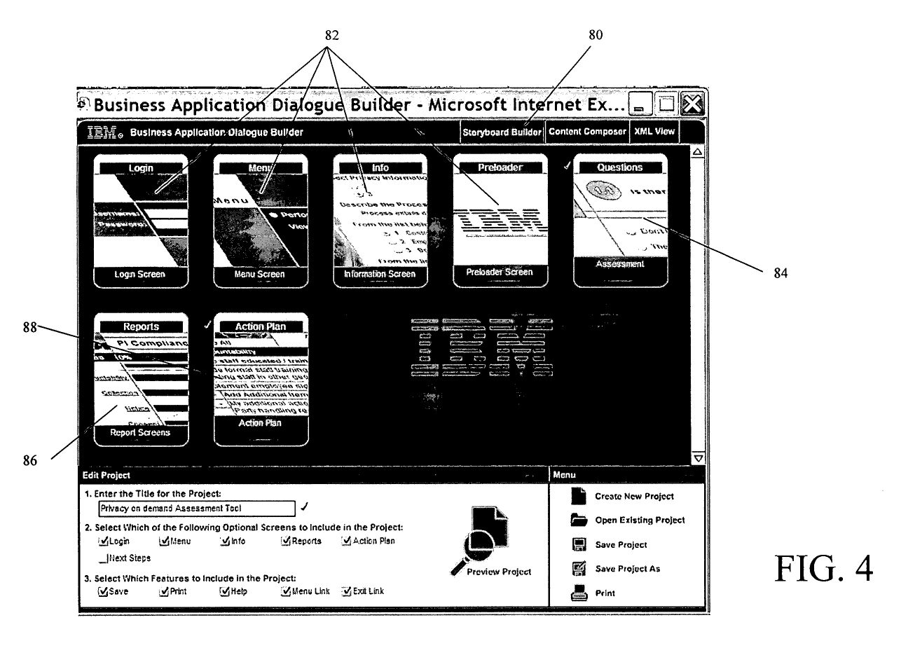

FIGS. 4-6 depict illustrative screenshots that could be implemented by the application dialogue toolkit 48 to create an application dialog 19. FIG. 4 depicts a storyboard builder interface 80 of an application dialogue toolkit 48 for selecting and creating frames, which form a project. In the example shown, seven frames are shown, which include a set of “front end” frames 82 that include login screen, menu screen, information screen, and preloader screen. The substantive frames for this project include an assessment (i.e., questions) frame 84, a report screens frame 86, and an action plan frame 88. Using this interface 80, the subject matter expert (SME) can add or remove (i.e., edit) frames that make up the storyboard of the business dialogue. The SME can also load existing projects and preview the project.

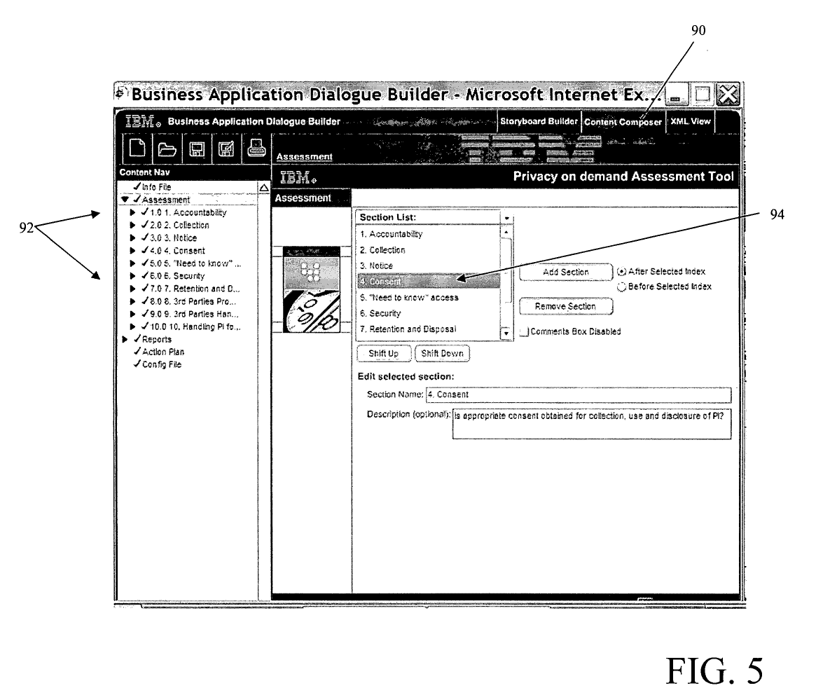

FIG. 5 depicts a content composer interface 90 of an application dialogue toolkit 48 for creating questionnaire content for the assessment frame 84 (FIG. 4). In this example, the assessment frame 84 depicts a set of talking points, referred to as “sections” 92. From this interface 90, the SME can select/add/remove a section and create/edit content for a selected section (e.g., in a pop-up window not shown). For instance, the SME may create multiple-choice or yes/no type questions and answers for each section.

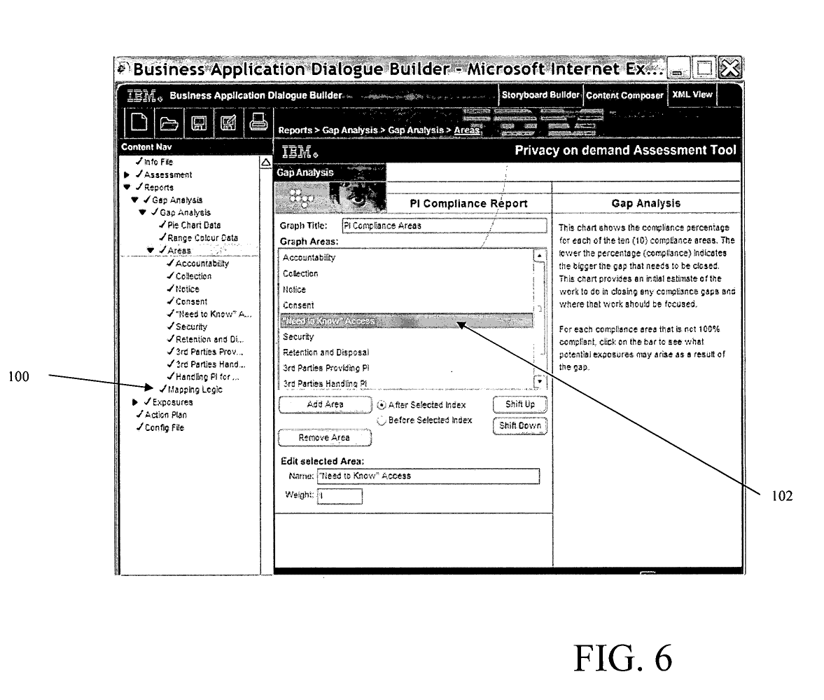

FIG. 6 depicts an interface of an application dialogue toolkit 48 for creating graphical reporting content, which would be shown in response to the questions and answers frame. In this case, the reporting is in the form of a gap analysis that will include graphical content (e.g., a pie chart) and text. From this interface, the SME can select a section 102 and enter/edit report content (e.g., in a pop-up window not shown). A series of interfaces are also provided that allows the SME to define the graphical and parameters related thereto. A mapping logic interface 100 can be selected to map questions/answers to the report. Mapping logic 100 allows the SME to determine what reports and graphical content are to be displayed in response to the answers given by the user.

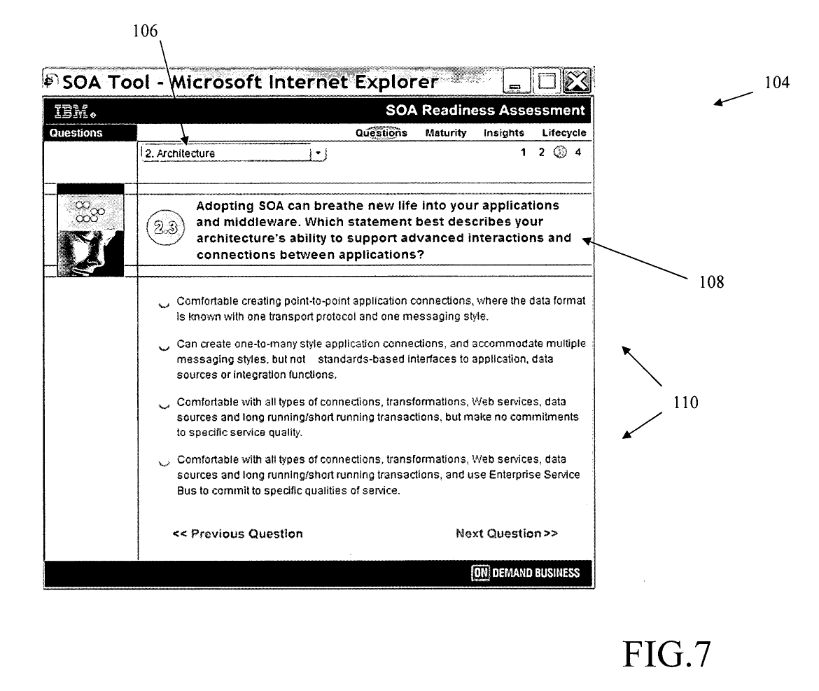

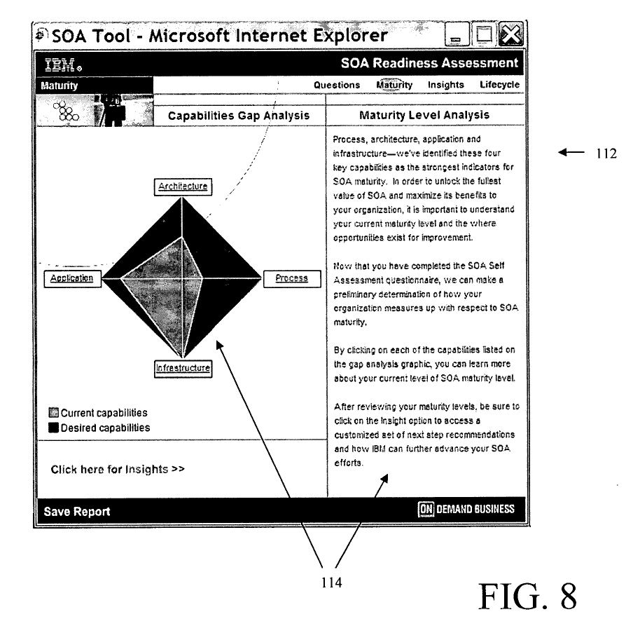

FIGS. 7 and 8 depict illustrative screenshots of an application dialog being executed in a runtime environment 14. FIG. 7 depicts a questionnaire interface 104 in which a user is presented with a question 108 regarding a specific talking point or section 106, in this case relating to “architecture.” A set of answers 100 are provided, which can be selected by the user. FIG. 8 depicts an assessment interface 112 relating to a gap analysis. In this case, a report 114 is provided based on the answers provided by the user to a set of assessment questions. Report 114 includes both graphical and textual content. From this screen, the user can drill down further into one of the capabilities shown on the graphic for a more detailed report.

In general, computer system 40 (FIG. 3) may comprise, e.g., a desktop, a laptop, a workstation, a handheld device, etc. Moreover, computer system 40 could be implemented as part of a client and/or a server. Computer system 40 generally includes a processor 42, input/output (I/O) 44, memory 46, and bus 47. The processor 42 may comprise a single processing unit, or be distributed across one or more processing units in one or more locations, e.g., on a client and server. Memory 46 may comprise any known type of data storage and/or transmission media, including magnetic media, optical media, random access memory (RAM), read-only memory (ROM), a data cache, a data object, etc. Moreover, memory 46 may reside at a single physical location, comprising one or more types of data storage, or be distributed across a plurality of physical systems in various forms.

I/O 44 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 47 provides a communication link between each of the components in the computer system 40 and likewise may comprise any known type of transmission link, including electrical, optical, wireless, etc. Although not shown, additional components, such as cache memory, communication systems, system software, etc., may be incorporated into computer system 40.

Access to computer system 40 may be provided over a network such as the Internet, a local area network (LAN), a wide area network (WAN), a virtual private network (VPN), a wireless network, etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising an application dialogue toolkit 48, as well as the runtime environment 44, could be created, maintained and/or deployed by a service provider that offers the functions described herein for customers. That is, a service provider could offer to provide a toolkit for building application dialogues and/or a runtime environment for executing application dialogues as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. An application dialogue toolkit for creating an application dialogue in accordance with a predefined architecture, comprising:
a configurator tool for defining at least one frame, wherein each frame includes a set of talking points capable of being presented to an end user, and wherein the configurator tool includes a system for defining a unique model to be associated with each frame; and
a content editor for populating and managing a content database associated with the application dialogue.

2. The application dialogue toolkit of claim 1, wherein the configurator tool further includes a system for defining a set of logical mapping tables.

3. The application dialogue toolkit of claim 1, wherein the configurator tool further includes a system for defining a look and feel of each frame.

4. The application dialogue toolkit of claim 1, further comprising an administration tool for managing authorization to the application dialogue.

5. A computer program product stored on a computer readable medium for creating an application dialogue in accordance with a predefined development protocol, comprising:
program code configured for defining at least one frame in accordance with the predefined development protocol, wherein each frame includes a set of talking points capable of being presented to an end user;
program code configured for defining a unique model in accordance with the predefined development protocol to be associated with each frame; and
program code configured for populating and managing a content database associated with the application dialogue in accordance with the predefined development.

6. The computer program product of claim 5, further comprising program code configured for defining a set of logical mapping tables.

7. The computer program product of claim 5, further comprising program code configured for defining a look and feel of each frame.

8. The computer program product of claim 5, further comprising program code configured for managing authorization to the application dialogue.

9. A method of creating an application dialogue in accordance with a predefined architecture, comprising:
providing a development platform for building the application in accordance with a predefined development protocol;
selecting at least one frame, wherein each frame includes a set of talking points capable of being presented to an end user;
defining a unique model to be associated with each frame; and
populating and managing a content database associated with the application dialogue.

10. The method of claim 9, further comprising defining a set of logical mapping tables.

11. The method of claim 9, further comprising defining a look and feel of each frame.

12. The method of claim 9, further comprising managing authorization to the application dialogue.

13. A computerized architecture for implementing an application dialogue constructed in accordance with a predefined development protocol, comprising:
a user interface;
a runtime environment having a set of frames that make up the application dialogue, wherein each frame includes a set of talking points that can be used to display expert knowledge and receive input from an end user via the user interface, and wherein the each frame includes an associated model and logic that determines what talking points should be displayed to the end user within a frame, and when to switch between frames; and
a content database for storing expert knowledge.

14. The computerized architecture of claim 13, further comprising an application dialogue toolkit for constructing the application dialogue.

15. The computerized architecture of claim 13, wherein the application dialogue performs a function selected from the group consisting of: advising, consultative selling, compliance, and assessments and diagnostics executed in support of an existing business process or transaction.

16. A method for deploying an application dialogue architecture and toolkit, comprising:
providing a computer infrastructure being operable to:
provide a user interface;
provide a runtime environment having a set of frames that make up the application dialogue, wherein each frame includes a set of talking points that can be used to display content and receive input from an end user via the user interface, and wherein the each frame includes an associated model and logic that determines what talking points should be displayed to the end user within a frame, and when to switch from a first frame to a second frame;
provide a content database for storing content; and
provide a toolkit for defining the set of frames and associated model and logic, and for populating and managing a content database associated with the application dialogue.
